(19) United States
(12) Patent Application Publication
(10) Pub. No.: US 2018/0340473 A1
(43) Pub. Date: Nov. 29, 2018

(54) COMBINED CYCLE POWER PLANT SYSTEM ARRANGEMENTS

(71) Applicant: General Electric Company, Schenectady, NY (US)

(72) Inventors: Prashant Agrawal, Baden (CH); Urszula Plochocka, Baden (CH); Borislav Dokic, Baden (CH); Sean O'Meara, Schenectady, NY (US); Christopher John Corron, Greenville, SC (US)

(21) Appl. No.: 15/984,206

(22) Filed: May 18, 2018

Related U.S. Application Data
(60) Provisional application No. 62/508,865, filed on May 19, 2017.

(51) Int. Cl. F02C 9/00; F02C 6/18; F22B 1/18

(52) U.S. Cl. CPC F02C 9/00; F22B 1/1815; F02C 6/18

(57) ABSTRACT

A 2×1 multi-shaft power island system is provided. The system includes a first gas turbine (GT)/gas turbine generator (GTG)/heat recovery steam generator (HRSG) island, the GT/GTG/HRSG island. The GT/GTG/HRSG island includes a first gas turbine system configured to produce power by combusting a fuel, and a first turbine generator system mechanically coupled to the first gas turbine system and configured to produce electrical power. The GT/GTG/HRSG island additionally includes a first HRSG system fluidly coupled to the first gas turbine system and configured to generate a first steam. The system further includes a second GT/GTG/HRSG island. The second GT/GTG/HRSG island includes a second gas turbine system configured to produce power by combusting the fuel, and a second turbine generator system mechanically coupled to the second gas turbine system and configured to produce electrical power.

### CROSS REFERENCE TO RELATED APPLICATIONS

This application claims priority from and the benefit of U.S. Provisional Application Ser. No. 62/508,865, entitled “COMBINED CYCLE POWER PLANT SYSTEM ARRANGEMENTS,” filed May 19, 2017, which is hereby incorporated by reference in its entirety for all purposes.

### BACKGROUND OF THE INVENTION

The subject matter disclosed herein relates to combined cycle power plants, and more specifically, to arrangement of systems for combine cycle power plants.

Combined cycle power plants combine gas turbine systems with steam turbine systems to produce electricity while reducing energy waste. In operation, the gas turbine systems combust a fuel-air mixture to create torque that drives a load, such as an electrical generator. In order to reduce energy waste, the combined cycle power plants use the thermal energy in the gas turbine system exhaust gases to create steam. The steam travels through a steam turbine system creating torque that drives a load such as an electrical generator. It would be beneficial to improve combined cycle power plant systems.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a 2×1 multi-shaft power island system is provided. The system includes a first gas turbine (GT)/gas turbine generator (GTG)/heat recovery steam generator (HRSG) island, the GT/GTG/HRSG island. The GT/GTG/HRSG island includes a first gas turbine system configured to produce power by combusting a fuel, and a first turbine generator system mechanically coupled to the first gas turbine system and configured to produce electrical power. The GT/GTG/HRSG island additionally includes a first HRSG system fluidly coupled to the first gas turbine system and configured to generate a first steam. The system further includes a second GT/GTG/HRSG island. The second GT/GTG/HRSG island includes a second gas turbine system configured to produce power by combusting the fuel, and a second turbine generator system mechanically coupled to the second gas turbine system and configured to produce electrical power. The second GT/GTG/HRSG island additionally includes a second HRSG system fluidly coupled to the second gas turbine system and configured to generate a second steam. The system also includes a steam turbine system fluidly coupled to the first HRSG system and to the second HRSG system and configured to produce power via the first steam and the second steam, and a steam turbine generator system mechanically coupled to the steam turbine system and configured to produce electrical power, wherein the steam turbine system is disposed in a location between the first GT/GTG/HRSG island and the second GT/GTG/HRSG island.

In a second embodiment, a method is provided. The method includes manufacturing a first gas turbine (GT)/gas turbine generator (GTG)/heat recovery steam generator (HRSG) island on a site. The GT/GTG/HRSG island includes a first gas turbine system configured to produce power by combusting a fuel, and a first turbine generator system mechanically coupled to the first gas turbine system and configured to produce electrical power. The GT/GTG/HRSG island additionally includes a first HRSG system fluidly coupled to the first gas turbine system and configured to generate a first steam. The method further includes manufacturing a second GT/GTG/HRSG island on the site. The second GT/GTG/HRSG island includes a second gas turbine system configured to produce power by combusting the fuel, and a second turbine generator system mechanically coupled to the second gas turbine system and configured to produce electrical power. The second GT/GTG/HRSG island also includes a second HRSG system fluidly coupled to the second gas turbine system and configured to generate a second steam. The method further includes disposing a steam turbine system on the site, the steam turbine system configured to fluidly couple to the first HRSG system and to the second HRSG system and to produce power via the first steam and the second steam. The method additionally includes disposing a steam turbine generator system on the site, the steam turbine generator mechanically coupled to the steam turbine system and configured to produce electrical power, wherein the steam turbine system is disposed in a location on the site between the first GT/GTG/HRSG island and the second GT/GTG/HRSG island.

In a third embodiment, a combined cycle power plant system is provided. The system includes a first power production island configured to produce electrical power and a second power production island configured to produce electrical power. The system further includes a steam turbine island comprising a steam turbine system and a steam turbine generator system mechanically coupled to the steam turbine system and configured to produce electrical power, wherein the steam turbine island is disposed in a location between the first power production island and the second power production island.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of combined cycle power plant systems;

FIG. 2 is a block diagram illustrating an embodiment of a 2×1 multi-shaft power island system that includes various systems of FIG. 1;

FIG. 3 is a block diagram illustrating another embodiment of a 2×1 multi-shaft power island system that may ameliorate or eliminate certain issues described with respect to the 2×1 multi-shaft power island system of FIG. 2;

FIG. 4 is a block diagram illustrating an embodiment of the 2×1 multi-shaft power island system of FIG. 3 in an east-west orientation;

FIG. 5 depicts an embodiment of the 2×1 multi-shaft power island system of FIG. 3 in an east-west orientation illustrating how placing a central cooler may result in a reduction of piping and related material;

FIG. 6 is a block diagram illustrating an embodiment of the 2×1 multi-shaft power island system of FIG. 3 in an east-west orientation to show certain piping distances;

FIG. 7 is a 3-dimensional (3D) view of an embodiment of a steam turbine system disposed between HRSGs, in the 2×1 multi-shaft power island system of FIG. 3.

FIG. 8 is a block diagram showing embodiments of three arrangements for certain power production systems;

FIG. 9 is a block diagram an embodiment of a 2×1 multi-shaft combined cycle power island where a steam turbine or steam turbine island is disposed between gas turbines;

FIG. 10 is a block diagram illustrating an embodiment of the 2×1 multi-shaft power island system of FIG. 9 in an east-west orientation to showcase certain improvements;

FIG. 11 is a block diagram of an embodiment of the 2×1 multi-shaft power island system of FIG. 9 in an east-west orientation illustrating the placing of certain cooling systems;

FIG. 12 is a block diagram illustrating an embodiment of the 2×1 multi-shaft power island system of FIG. 9 in an east-west orientation to show certain piping distances; and

FIG. 13 is a block diagram illustrating an embodiment of the 2×1 multi-shaft power island system of FIG. 9 in an east-west orientation showing how a single building and a single common main crane may house and service a steam turbine, a steam turbine generator, and gas turbines; and

FIG. 14 is a flowchart of an embodiment of a process suitable for manufacturing power production plants, and more specifically, power production plants that incorporate the techniques described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to combine cycle power plant systems, such as multi-shaft power island systems. The techniques described herein include specific types of advantageous arrangements for multi-shaft power island. A multi-shaft power island system may include two gas turbine systems, two associated electrical generator systems, two heat recovery steam generator (HRSG) systems, as well as a side exhaust steam turbine system and an associated electrical generator. An advantageous feature of certain arrangements described herein is a location and an orientation of the steam turbine. In one example, a steam turbine/generator island is located between the two HRSG systems or between the two gas turbine systems and perpendicular to the gas turbine/generator/HRSG islands, as further described below.

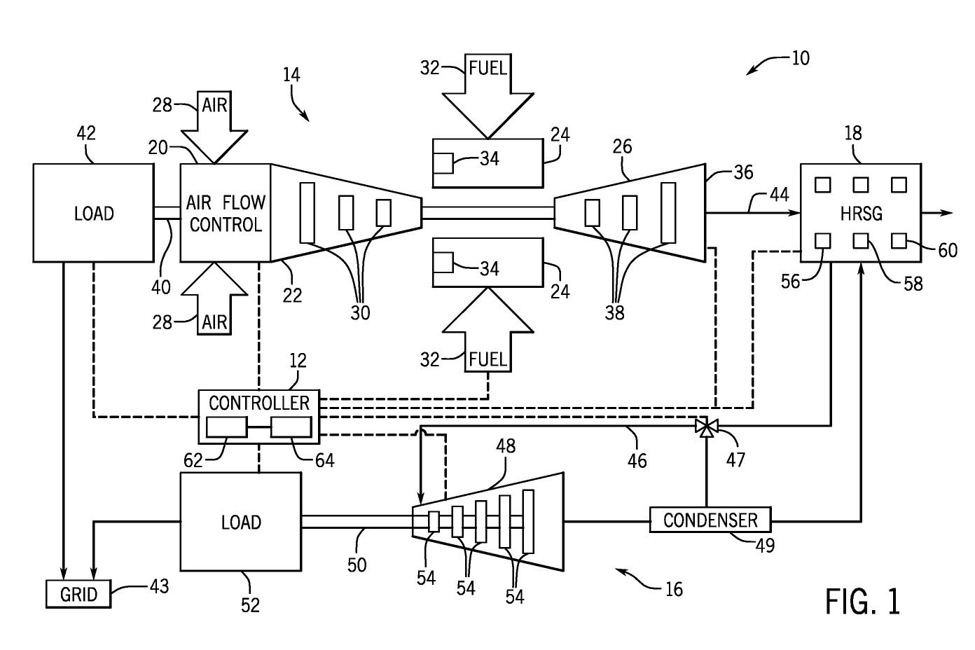

It may be beneficial to describe systems included in a combined cycle power production system or plant. Accordingly, and turning now to FIG. 1, the figure is a block diagram of an embodiment of a combined cycle power system 10 with a control system 12 that provides for control operations of the combined cycle power production system 10. The combined cycle power production system 10 further includes a gas turbine system 14, a steam turbine system 16, and a heat recovery steam generator (HRSG) system 18. In operation, the gas turbine system 14 combust a fuel-air mixture to create torque that drives a load, e.g., an electrical generator. In order to reduce energy waste, the combined cycle power production system 10 uses the thermal energy in the exhaust gases to heat a fluid and create steam in the HRSG system 18. The steam travels from the HRSG system 18 through a steam turbine system 16 creating torque that drives a load, e.g., an electrical generator. Accordingly, the combined cycle power system 10 combines the gas turbine system 14 with steam turbine system 16 to increase power production while reducing energy waste (e.g., thermal energy in the exhaust gas).

The gas turbine system 14 includes an airflow control system 20, compressor 22, combustor 24, and turbine 26. In operation, an oxidant 28 (e.g., air, oxygen, oxygen enriched air, or oxygen reduced air) enters the turbine system 14 through the airflow control system 20, which controls the amount of oxidant flow (e.g., airflow). The airflow control system 20 may control airflow by heating the oxidant flow, cooling the oxidant flow, extracting airflow from the compressor 22, using an inlet restriction, using an inlet guide vane, or a combination thereof. As the air passes through the airflow control system 20, the air enters the compressor 22. The compressor 22 pressurizes the air 28 in a series of compressor stages (e.g., rotor disks 30) with compressor blades. As the compressed air exits the compressor 22, the air enters the combustor 24 and mixes with fuel 32. The turbine system 14 may use liquid or gas fuel, such as natural gas and/or a hydrogen rich synthetic gas, to run the turbine system 14. For example, the fuel nozzles 34 may inject a fuel-air mixture into the combustor 24 in a suitable ratio for more optimal combustion, emissions, fuel consumption, and power output. As depicted, a plurality of fuel nozzles 34 intakes the fuel 32, mixes the fuel 32 with air, and distributes the air-fuel mixture into the combustor 24. The air-fuel mixture combusts in a combustion chamber within combustor 24, thereby creating hot pressurized exhaust gases. The combustor 24 directs the exhaust gases through a turbine 26 toward an exhaust outlet 36. As the exhaust gases pass through the turbine 26, the gases contact turbine blades attached to turbine rotor disks 38 (e.g., turbine stages). As the exhaust gases travel through the turbine 26, the exhaust gases may force turbine blades to rotate the rotor disks 38. The rotation of the rotor disks 38 induces rotation of shaft 40 and the rotor disks 32 in the compressor 26. A load 42 (e.g., electrical generator) connects to the shaft 40 and uses the rotation energy of the shaft 40 to generate electricity for use by an electric power grid 43.

As explained above, the combined cycle power production system 10 harvests energy from the hot exhaust gases exiting the gas turbine system 14 for use by the steam turbine system 16. Specifically, the combined cycle power production system 10 channels hot exhaust gases 44 from the turbine system 14 into the heat recovery steam generator (HRSG) 18 for further energy capture. In the HRSG 18, the thermal energy in the combustion exhaust gases converts water into hot pressurized steam 46. The HRSG 18 releases the steam 46 for use in the steam turbine system 16.

The steam turbine system 16 includes a turbine 48, shaft 50, and load 52 (e.g., electrical generator). As the hot pressurized steam in line 46 enters the steam turbine 48, the steam contacts turbine blades attached to turbine rotor disks 54 (e.g., turbine stages). As the steam passes through the turbine stages in the turbine 48, the steam induces the turbine blades to rotate the rotor disks 54. The rotation of the rotor disks 54 induces rotation of the shaft 50. As illustrated, the load 52 (e.g., electrical generator) connects to the shaft 50. Accordingly, as the shaft 50 rotates, the load 52 (e.g., electrical generator) uses the rotation energy to generate electricity for the power grid 43. As the pressurized steam in line 46 passes through the turbine 48, the steam loses energy (i.e., expands and cools). After exiting the steam turbine 48, the steam enters a condenser 49 before being routed back to the HRSG 18, where the steam is reheated for reuse in the steam turbine system 16. It is to be noted that the HRSG 18 may include a variety of components, such as one or more boilers 56, attemperators 58, drums 60, and so on. For example, the boilers 56 may convert water into steam, while the attemperators 58 may adjust steam temperature, for example, by spraying water into the steam. Likewise, drums 60 may be used as repositories of water, steam, and the like. It is to be noted that the HRSG 18 may include other components, such as superheaters 61, deareators 63, economizers 65, and so on.

The control system 12 includes one or more memories 62 and one or more processors 64. The memory 62 stores instructions and steps written in software code. The processor 64 executes the stored instructions, for example, in response to feedback received from sensors in the combined cycle power production system 10. More specifically, the control system 12 controls and communicates with various components in the combined cycle power production system 10 in order to flexibly control the loading and unloading of the gas turbine system 14, and thus the loading and unloading of the steam turbine system 16, power production, steam production, and so on. In operation, the control system 12 may control the airflow control system 20 and the consumption of fuel 32 to change the loading of the gas turbine system 14 and thereby the loading of combined cycle power production system 10 (i.e., how the combined cycle power production system 10 increases electrical power output to the grid 43). For example, the control system 12 may adjust the mass flow rate and temperature of the exhaust gas 44, which controls how rapidly the HRSG 18 produces steam for the steam turbine system 16, and therefore, how quickly the combined cycle power production system 10 produces electrical power using loads 42 and 52. For example, when the control system 12 increases the airflow with the airflow control system 20, it increases the amount of airflow flowing through the compressor 22, flow through the combustor 24, and flow through the turbine 26. The increase in airflow increases the mass flow rate of the exhaust gas, and thus the torque of the shaft 40. Likewise, the airflow control system 20 may be used to reduce airflow flowing through the compressor 22, through the combustor 24, and flow through the turbine 26. The decrease in airflow decreases the mass flow rate of the exhaust gas, and thus the torque of the shaft 40.

The control system 12 may additionally control fuel consumption by the gas turbine system 14. Control of the fuel 32 affects the mass flow rate through the gas turbine system 14 and the thermal energy available for the HRSG 18. For example, when the controller 12 increases fuel consumption the temperature of the exhaust gas 44 increases. The increase in the exhaust gas 44 temperature enables the HRSG 18 to produce steam at higher temperatures and pressures, which translates into more power production by the steam turbine system 16. However, when the control system 12 decreases fuel consumption there is a reduction in the temperature of the exhaust gas. Accordingly, there is less mechanical energy available to drive load 42 and less thermal energy available to produce steam for the steam turbine system 16 to drive load 52. In certain embodiments the control system 12 may be a distributed control system (DCS) where autonomous controllers are distributed throughout the combined cycle power production system 10, but there is central operator supervisory control.

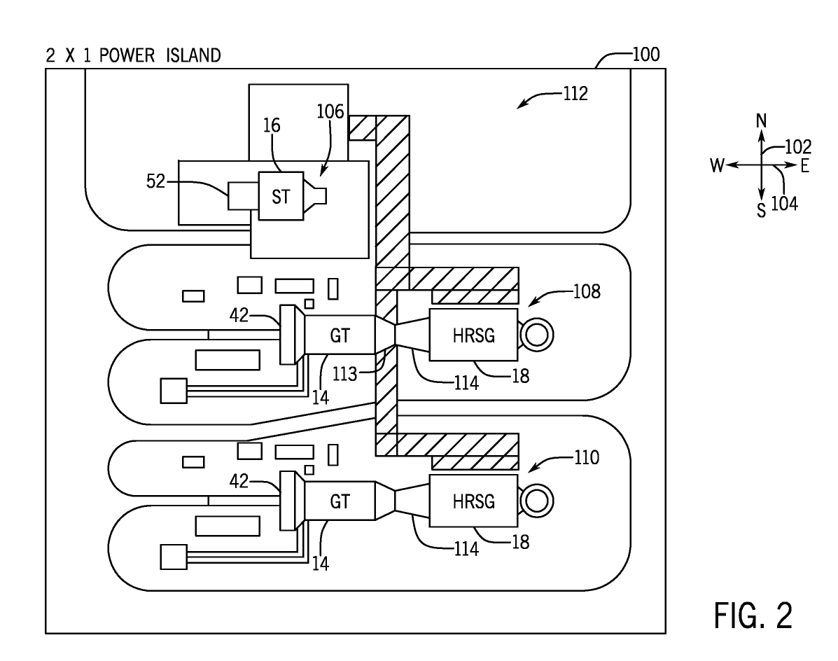

Turning now to FIG. 2, the figure is a block diagram illustrating an embodiment of a 2×1 multi-shaft power island system 100 that includes two gas turbine systems 14 fluidly coupled to two HRSG systems 18. Each of the two HRSG systems 18 is then fluidly coupled to one steam turbine system 16. The nomenclature “2×1” thus refers to two gas turbines 14 and HRSGs 18, where the HRSGs 18 provide steam to one steam turbine 16. There are two shaft systems, one in each gas turbine 14 load or generator 42 combination, and one shaft system in the steam turbine 16 load 52 combination. Because the figure includes like elements to FIG. 1, the like elements are depicted with like numbers. To aid in spatial directions for certain arrangement of the depicted systems, axes 102 and 104 are provided, having a north (N), south (S), east (E), and west (W) directions, respectively. It is to be understood that axes 102, 104 may not necessarily correspond to magnetic directions or poles, or geographic directions or poles.

The depicted 2×1 multi-shaft combined cycle power island 100 locates a steam turbine (ST)/steam turbine generator (STG) island 106 (e.g., steam turbine 16 and load or generator 52) to one side (e.g. north side as depicted in the figure) of a gas turbine (GT) 14/gas turbine generator (GTG) 42/HRSG 18 island 108. This enables construction of the ST/STG island 106 to proceed relatively independent of the construction of GT/GTG/HRSG islands 108 and 110, but may create several issues, including those listed below. The islands 106, 108, 110 create power, such as electrical and/or mechanical power, and are thus power islands.

One issue includes systems that support the entire power island 100, such as electrical distribution, and auxiliary cooling water may not be centrally located as free space for these systems is typically to the east, or behind the steam turbine 16 building. This location 112 increases the quantities of interconnecting piping and cabling between these systems and the equipment they support.

A second issue is that the south-most GT/GTG/HRSG island 110 is typically located approximately 300 feet from the ST/STG island 106. Therefore, a large quantity of alloy steam piping is likely to be used to deliver steam to from the south most HRSG 18 to the steam turbine 16.

A third issue is that alloy steam piping 113 from the south-most HRSG 18 transits over an exhaust system 114 of the adjacent gas turbine 14 to deliver steam to the steam turbine 16. During power plant construction, installation of this steam piping 113 can interfere with the installation of the gas turbine exhaust system 114 in this area.

A fourth issue is that a plant control room and/or auxiliary control room are not centrally located in the power island 100 as there is little or no free space in the center of the power island 100. Therefore, plant control personnel and systems must be located at the edge of the power island, e.g., area 112. This lengthens response times when personnel must physically access equipment.

A fifth issue with power island 100 is that one GT/GTG island, island 108 in the depicted figure, is trapped between the adjacent GT/GTG island 110 and the ST/STG island 106. This reduces access to the trapped GT/GTG 108 and may somewhat impede maintenance.

A sixth issue is that because of the close spacing of the HRSG's 18 it becomes difficult to locate boiler feed pumps (BFPs) between them. Therefore, if a client of the power island 100 requires a redundancy in their BFPs, an additional BFP must be provided for each HRSG 18 for a total of four pumps. Accordingly, it is not economical for both HRSGs to share a single backup pump due to the long piping runs that would result.

A seventh issue is that two separate buildings may be required for rotating equipment's like two gas turbines 14 and steam turbine 16/steam turbine generator 52. This requires a minimum two quantities of main cranes for maintenance of gas turbines 14 and steam turbine 16/steam turbine generator 52.

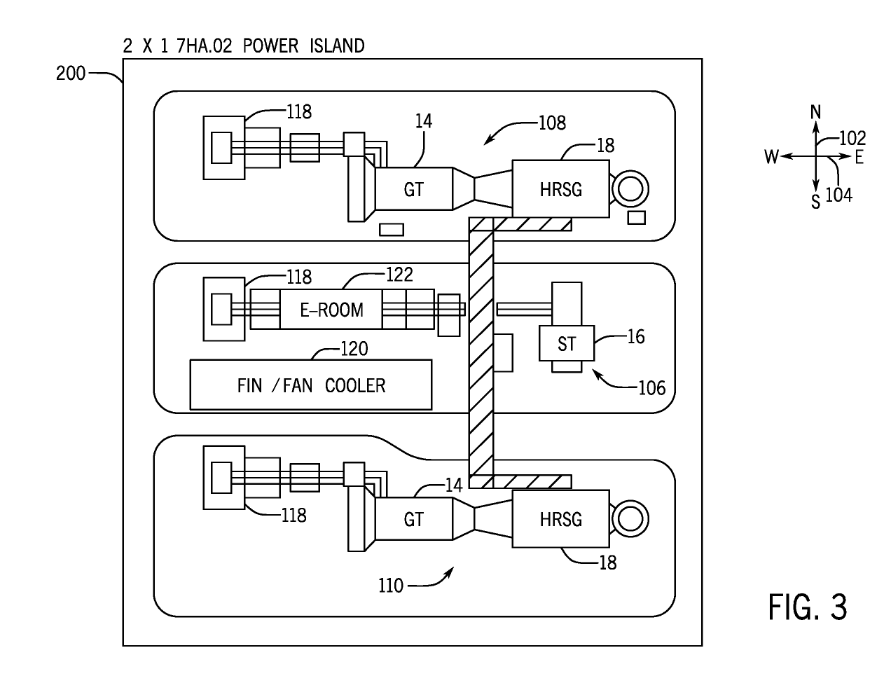

FIG. 3 is a block diagram illustrating an embodiment of a 2×1 multi-shaft power island system 200 that may ameliorate or eliminate the issues described with respect to the 2×1 multi-shaft power island system 100 of FIG. 2. More specifically, the 2×1 multi shaft power island 200 configuration may result in less construction material quantities (e.g., piping material, electrical conduit material, and so on), lower cost of construction, and improved equipment access by construction, maintenance and/or operations personnel. Because the figure includes like elements to FIGS. 1 and 2, the like elements are depicted with like numbers.

The depicted embodiment of the a 2×1 multi-shaft power island system 200 locates the ST/STG island 106 between the two HRSGs 18 and positions a ST/STG island 106 centerline perpendicular to the GT/GTG/HRSG islands 108, 110 centerlines. More specifically, the steam turbine 16 or steam turbine island 106 may be disposed directly below the north HRSG 18 and directly above the HRSG 18. Positioning the ST/STG island 106 between the GT/GTG/HRSG islands 108, 110 “pushes” the GT/GTG/HRSG islands 108, 110 further apart relative to the 2×1 power island 100 of FIG. 1 and resolve some of the issues previously described with the 2×1 multi-shaft power island system 100. For example, extra space is provided between the north and south GT/GTG systems 14, 42. This arrangement as shown provides a central area to locate power island systems such as electrical distribution systems 118 and auxiliary cooling, e.g., via fin/fan cooler system 120. An e-room system 122 is also depicted, suitable for hosting, for example, the control system 12 (or portions of the control system 12), electrical systems, and so on. Thus, the arrangement as shown in FIG. 3 reduces interconnecting piping and cabling quantities relative to the 2×1 power island arrangement of FIG. 2 and results in lower costs.

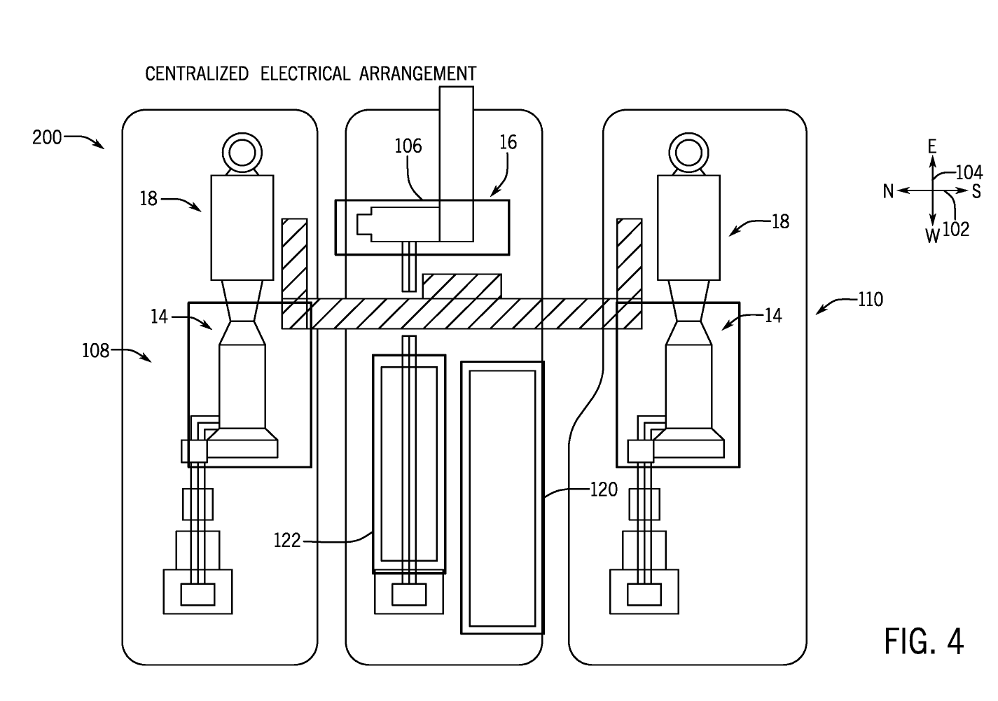

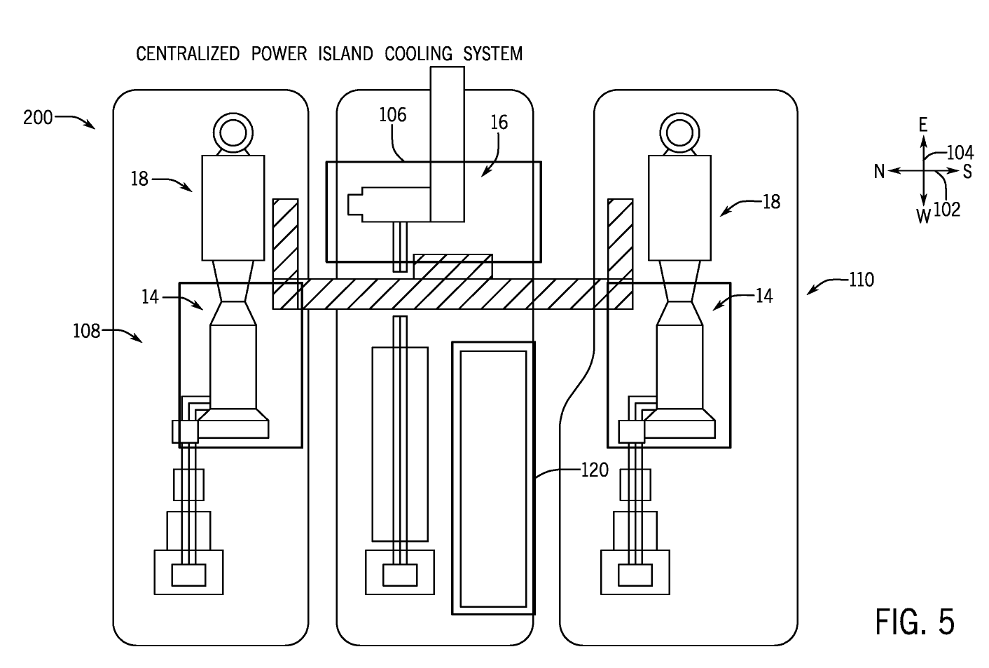

FIG. 4 is a block diagram illustrating an embodiment of the 2×1 multi-shaft power island system 200 in an east-west orientation to showcase certain improvements. Because the figure includes like elements to FIGS. 1-3, the like elements are depicted with like numbers. In the depicted embodiment, the e-room 122 is clearly shown disposed in a central location between the GT/GTG/HRSG island 108 and the GT/GTG/HRSG island 110, and west of the ST/STG island 106. Similarly, FIG. 5 depicts an embodiment of the 2×1 multi-shaft power island system 200 in an east-west orientation illustrating how placing a central cooler, e.g., the fin/fan cooler system 120, may result in a reduction of piping and related material. Because the figure includes like elements to FIGS. 1-3, the like elements are depicted with like numbers. The arrangement shown enables primary consumers of cooling water, such as gas turbines 14 and/or lube oil systems (e.g., systems that lubricate the gas turbines 14) to be in closer proximity to the fin/fan cooling system 120.

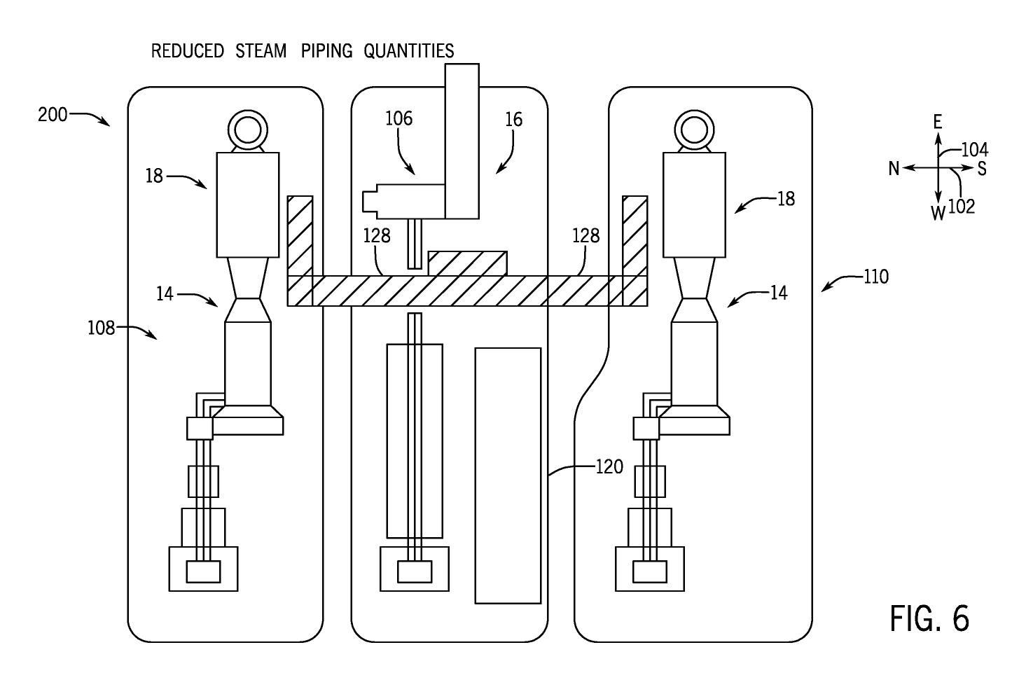

FIG. 6 is a block diagram illustrating an embodiment of the 2×1 multi-shaft power island system 200 in an east-west orientation to show certain piping distances. As depicted, placing the steam turbine 16 between HRSGs 18 may enable reduction in steam pipe 128 quantities of between 5%-50%. Indeed, because both gas turbine 14 HRSG 18 centerlines are approximately 150 feet from the steam turbine 16, placing the steam turbine 16 between the HRSGs 18 reduces the quantities of interconnecting alloy steam piping between the HRSG 18 outlets and the steam turbine 16 inlets by approximately 20% relative to the 2×1 multi-shaft power island system 100. For example, the longest pipe run of piping interconnecting the steam turbine 16 to either of the HRSGs 18 may be 150 ft. or less.

Other advantages of the 2×1 multi-shaft power island system 200 include that a centralized plant electrical system functions as the auxiliary plant control room and is centrally located in the 2×1 multi-shaft power island system 200. This is particularly beneficial during plant construction and testing as it provides a central location for operating, testing and isolating all power island 200 systems. Personnel have only a short distance to walk from the auxiliary control room to the equipment being tested or serviced. Further, both gas turbines 14 in the 2×1 multi-shaft power island system 200 are easily accessed from either side, and there is no trapped gas turbine 14. There is no restriction on access for either construction or maintenance.

There is enough space between the two HRSGs 18 to centrally locate their respective boiler feed pumps. Therefore, customers requiring redundancy in the BFP system can be served by one back-up BFP located adjacent to the two primary BFPs. This single back-up pump provides redundancy should either of the two primary pumps fail during operation. This reduces the total number of BFPs required for redundancy from four, for the typical power island, to three for this invention. This results in lower plant material costs and installation labor.

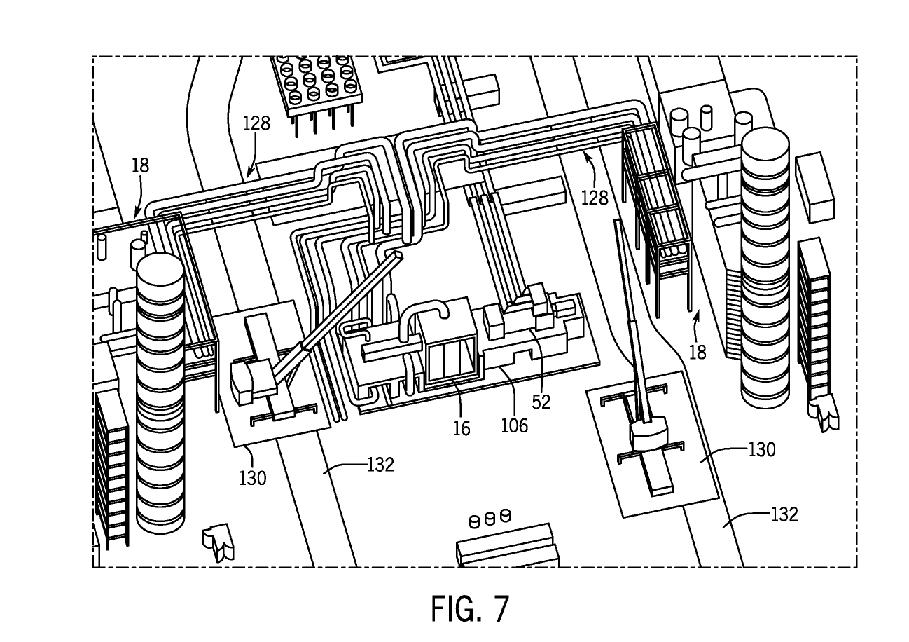

Turning now to FIG. 7, the figure illustrates a 3-dimensional (3D) view of the steam turbine 16 disposed between HRSGs 18 in the 2×1 multi-shaft power island system 200. As shown, two cranes 130 may be disposed and/or transported via roads 132, for example, to aid in the manufacture of the 2×1 multi-shaft power island system 200. Also shown are HRSG piping 128 having shorter distances when compared to similar piping found in 2×1 multi-shaft power island system 100.

In summary, the 2×1 multi-shaft power island system 200 may provide for centralized location for electrical and power island support systems while reducing interconnecting piping and cable quantities. Shorter piping and cable lengths reduce plant costs. The centralized location of the steam turbine 16 reduces the quantity of alloy piping required to deliver steam from the HRSGs 18 to the steam turbine 16. This shorter piping runs reduce plant costs. This benefit is magnified for plants with high steam temperatures and pressure. The piping for these plants are usually made of more exotic alloys due to the higher steam conditions. Reduction in piping lengths has a greater impact as the cost of the material rises. Steam piping does not travel over gas turbine 14 exhaust, simplifying installation of both and reducing installation costs.

Further, central location of electrical and control hardware places it near the equipment controlled. This is particularly advantageous during plant construction as it provided a central location for electrical isolation of equipment. This allows the plant construction and commissioning personnel to function more efficiently than if the electrical isolations were at the perimeter of the power island 200. Full access to all major equipment, gas turbines 14, loads 42, steam turbine 16, load 52, and HRSGs 18 for easy construction and maintenance. This enhances accessibility enables more efficient construction and maintenance work, reducing the cost of both.

The arrangement shown with respect to the 2×1 multi-shaft power island system 200 provides space for central location of boiler feed pumps. This allows the HRSGs 18 to economically share a single spare boiler feed pump for redundancy in a “3×100%” arrangement, rather than the “4×100%” pump arrangement that is required for redundancy of the 2×1 power island 100. The location and orientation of the steam turbine 16 simplifies the routing of the steam piping. Expansion loops are reduced due to piping length reduction. Also, the basic orientation of the piping makes it is essentially one large expansion loop, thereby managing piping stresses. Placing the steam turbine 16 between the HRSGs 18 positions the steam turbine 16 to the rear of the power island 200 and next to the typical location for the primary plant cooling system, normally an air-cooled condenser or wet cooling tower. Having the steam turbine 16 in close proximity to the cooling system reduces interconnecting piping/ducting and further reduces plant costs.

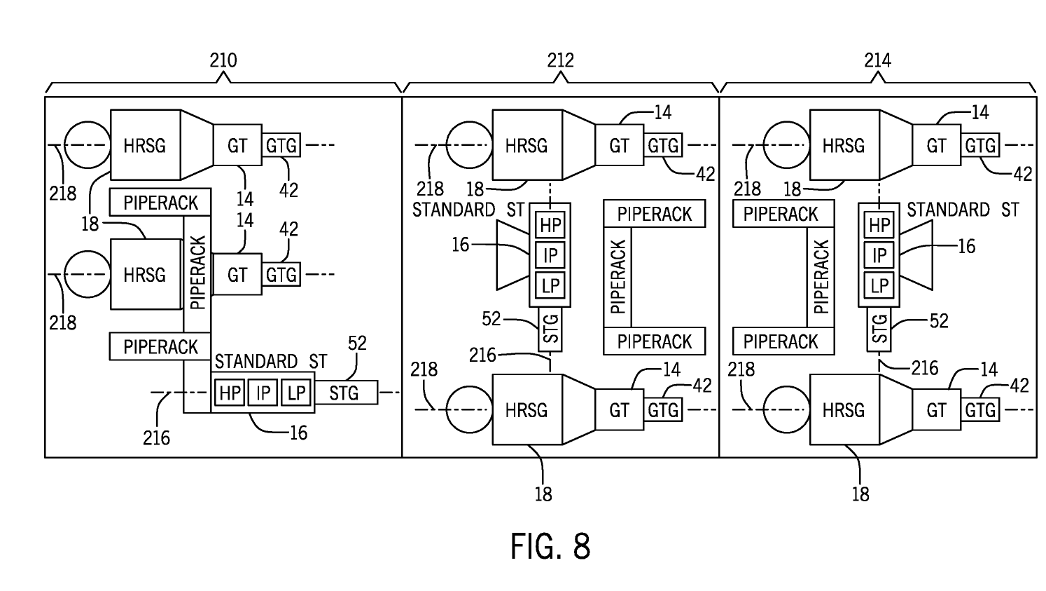

The techniques described herein provide for various arrangements as described in more detail with respect to FIG. 8. More specifically, FIG. 8 is a block diagram showing embodiments of three arrangements 210, 212, and 214 side-by-side. Arrangement 210 corresponds to having the steam turbine 16 disposed on a side, such as described with respect to 2×1 multi-shaft power island system 100. Arrangement 212 corresponds to having the steam turbine 16 disposed between HRSGs 18, such as described with respect to 2×1 multi-shaft power island system 200. As depicted, a centerline 216 of the steam turbine 16 (and load or generator 52) is perpendicular to centerlines 218 of the HRSG 18 (and gas turbine 14, load or generator 42). Arrangement 214 is similar to arrangement 212 but the steam turbine is disposed between the gas turbines 14 instead of between the HRSGs 18. Advantages of arrangement 214 are further described below.

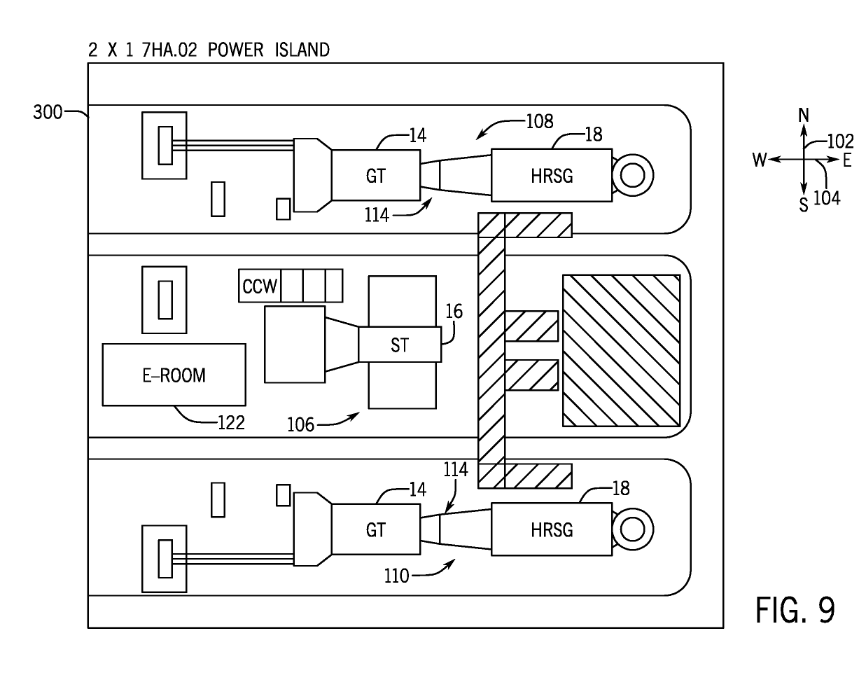

Turning now to FIG. 9, the figure depicts an embodiment of a 2×1 multi-shaft combined cycle power island 300 where the steam turbine 16 or steam turbine island 106 is disposed between the gas turbines 14. More specifically, the steam turbine 16 or steam turbine island 106 may be disposed directly below the north gas turbine 14 and directly above the south gas turbine 14. Space is created between the HRSGs 18. This provides a central area to locate power island systems such as electrical distribution and auxiliary cooling. This reduces interconnecting piping and cabling quantities relative to the 2×1 power island 100 and results in lower costs.

The arrangement shown in FIG. 9 will provide space between two HRSGs 18 for equipment laydown. This facilitates plant construction and equipment maintenance. Both gas turbine 14/gas turbine generator 42/HRSG 18 centerlines are approximately 150 feet from the steam turbine 16/steam generator 52. Placing the steam turbine 16/steam generator 52 between the gas turbines 14 reduces the quantities of interconnecting alloy steam piping between the HRSG 18 outlets and the steam turbine inlets by approximately 20% relative to the 2×1 power island 100.

Alloy steam piping does not transit over the either of the gas turbine 14 exhaust ducts 114. Therefore, work in this piping does not interfere with the construction of the gas turbine exhaust. The centralized plant electrical system functions as the auxiliary plant control room and is centrally located in the power island 300. This is particularly beneficial during plant construction and testing as it provides a central location for operating, testing and isolating all power island 300 systems. Personnel have only a short distance to walk from the auxiliary control room to the equipment being tested or serviced. Both HRSGs 18 in the invention are easily accessed from either side. There is no restriction on access for either construction or maintenance.

There is enough space between the two HRSGs 14 to centrally locate their boiler feed pumps. Therefore, customers requiring redundancy in the BFP system can be served by one back-up BFP located adjacent to the two primary BFPs. This single back-up pump provides redundancy should either of the two primary pumps fail during operation. This reduces the total number of BFPs required for redundancy from four, for the typical power island, to three for this invention. This results in lower plant material costs and installation labor.

With proposed arrangement for the 2×1 power island 300, i.e. steam turbine 16/steam turbine generator 52 placed between gas turbines 14, one common building may be used for main rotating equipment such as gas turbines 14 and steam turbine 16/steam turbine generator 52. This enables maintenance of main rotating equipment via one single crane.

In summary with respect to the 2×1 power island 300, a centralized location for electrical and power island support systems reduces interconnecting piping and cable quantities. Shorter piping and cable lengths reduce plant costs. The centralized location of the steam turbine 16 reduces the quantity of alloy piping required to deliver steam from the HRSGs 18 to the steam turbine 16. This shorter piping runs reduce plant costs. This benefit is magnified for plants with high steam temperatures and pressure. The piping for these plants must be made of more exotic alloys due to the higher steam conditions. Reduction in piping lengths has a greater impact as the cost of the material rises. Steam piping does not travel over gas turbine 14 exhaust 114, simplifying installation of both and reducing installation costs.

Central location of electrical and control hardware places it near the equipment controlled. This is particularly advantageous during plant construction as it provided a central location for electrical isolation of equipment. This allows the plant construction and commissioning personnel to function more efficiently than if the electrical isolations were at the perimeter of the power island. Full access to all major equipment, gas turbines 14, gas turbine generators 42, steam turbine 16, steam turbine generator 52, and HRSGs 18 for easy construction and maintenance. This enhances accessibility enables more efficient construction and maintenance work, reducing the cost of both.

The arrangement provides space for central location of boiler feed pumps. This allows the HRSGs 18 to economically share a single spare boiler feed pump for redundancy in a “3×100%” arrangement, rather than the “4×100%” pump arrangement that is required for redundancy of the 2×1 power island 100 arrangement. The location and orientation of the steam turbine 16 simplifies the routing of the steam piping. Expansion loops are reduced due to piping length reduction. Also, the basic orientation of the piping makes it is essentially one large expansion loop, thereby managing piping stresses. Placing the steam turbine 16 between the gas turbines 14, the main and secondary cooling units are placed at centralized position of power island 300. This allows short interconnecting piping and further reduces plant costs.

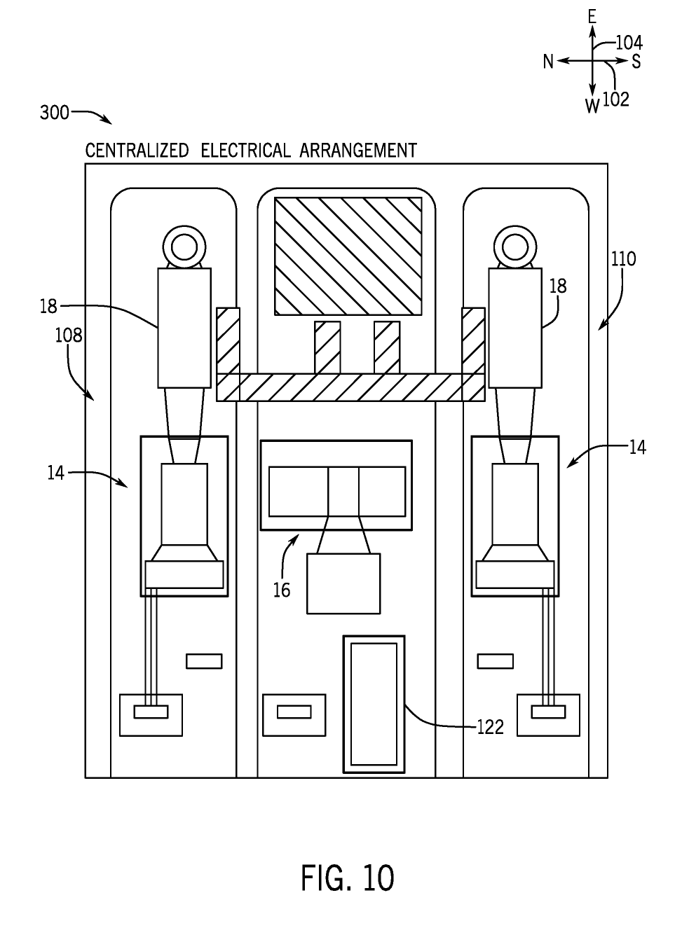

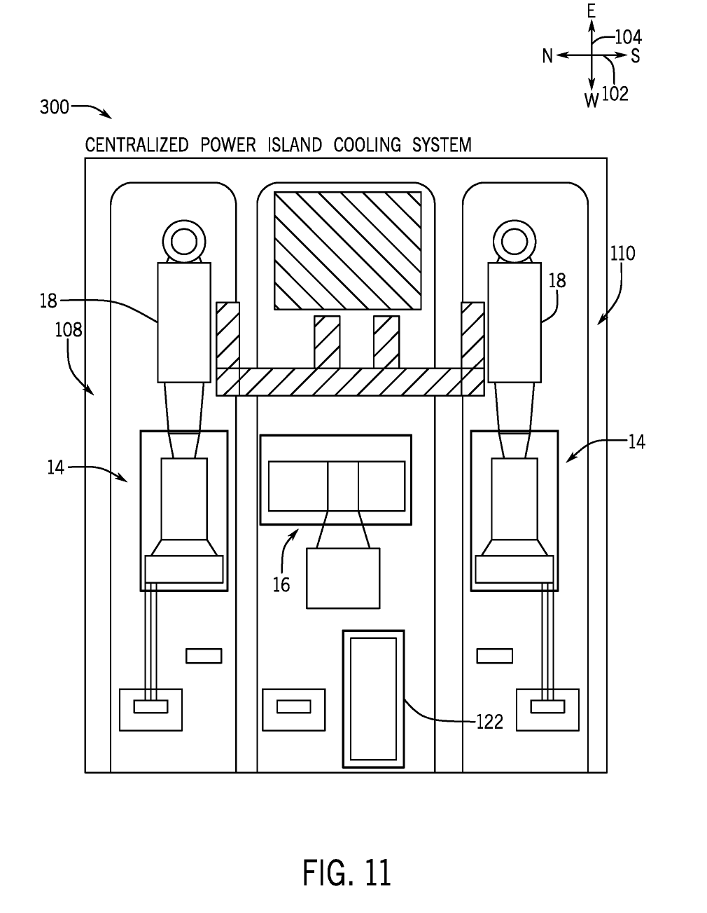

FIG. 10 is a block diagram illustrating an embodiment of the 2×1 multi-shaft power island system 300 in an east-west orientation to showcase certain improvements. Because the figure includes like elements to FIGS. 1-9, the like elements are depicted with like numbers. In the depicted embodiment, the e-room 122 is clearly shown disposed in a central location between the GT/GTG/HRSG island 108 and the GT/GTG/HRSG island 110, and south of the ST/STG island 106. Similarly, FIG. 11 depicts an embodiment of the 2×1 multi-shaft power island system 300 in an east-west orientation illustrating how placing certain cooling systems, e.g., clarified cooling water (CCW) systems and/or main cooling water (MCW) systems, may result in a reduction of piping and related material. Because the figure includes like elements to FIGS. 1-10, the like elements are depicted with like numbers. The arrangement shown enables primary consumers of cooling water, such as gas turbines 14 and/or lube oil systems (e.g., systems that lubricate the gas turbines 14) to be in closer proximity to the CCW and/or MWC systems.

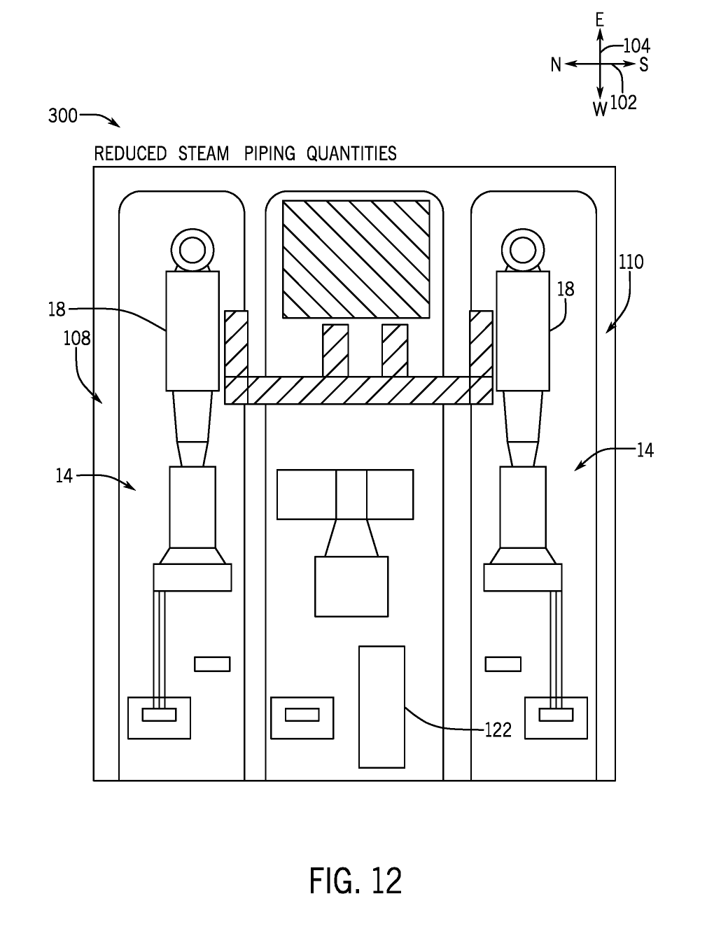

FIG. 12 is a block diagram illustrating an embodiment of the 2×1 multi-shaft power island system 300 in an east-west orientation to show certain piping distances. Because the figure includes like elements to FIGS. 1-11, the like elements are depicted with like numbers. As depicted, placing the steam turbine 16 between gas turbines 14 may enable reduction in steam pipe 128 quantities of between 5%-50%. Indeed, because both gas turbine 14 HRSG 18 centerlines are approximately 150 feet from the steam turbine 16, placing the steam turbine 16 between the gas turbines 14 reduces the quantities of interconnecting alloy steam piping between the HRSG 18 outlets and the steam turbine 16 inlets by approximately 20% relative to the 2×1 multi-shaft power island system 100. For example, the longest pipe run of piping interconnecting the steam turbine 16 to either of the HRSGs 18 may be 150 ft. or less.

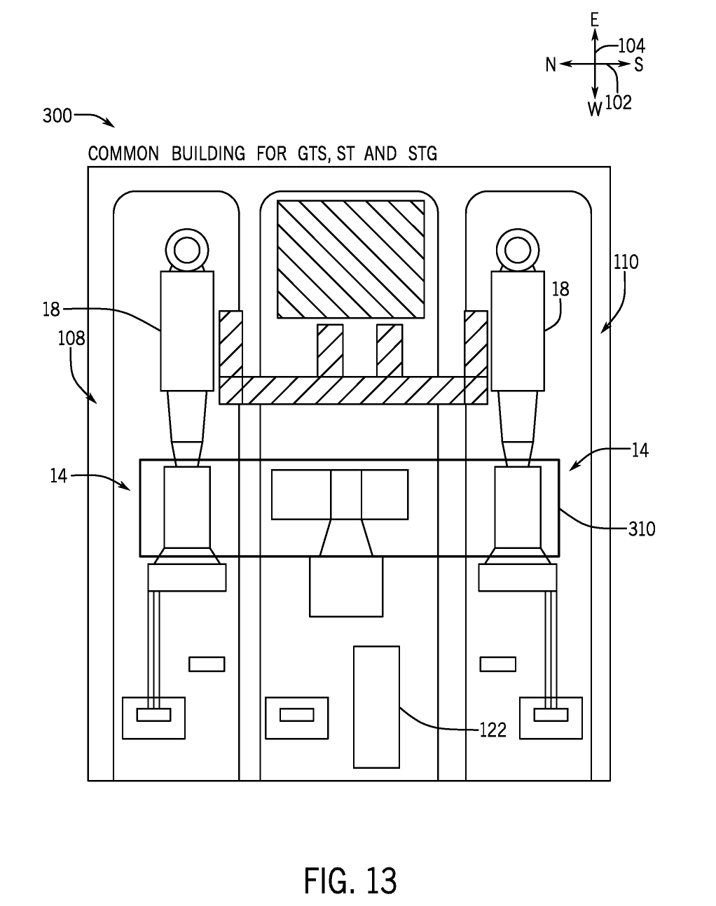

FIG. 13 is a block diagram illustrating an embodiment of the 2×1 multi-shaft power island system 300 in an east-west orientation. Because the figure includes like elements to FIGS. 1-9, the like elements are depicted with like numbers. The figure depicts the use of a single building 310 that may be used to house the steam turbine 16, the steam turbine generator 52, and the gas turbines 14. That is, because the steam turbine 16 is disposed between the gas turbines 14, and single building may be used to house the steam turbine 16, the steam turbine generator 52, and the gas turbines 14. Accordingly, a single main crane may service the steam turbine 16, the steam turbine generator 52, and the gas turbines 14.

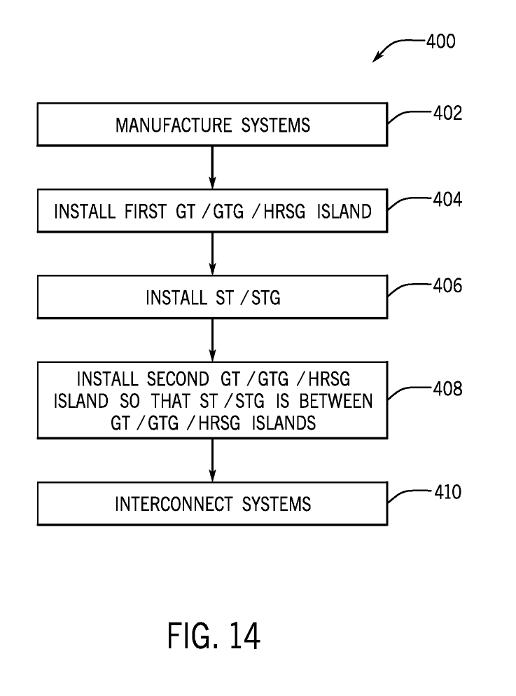

FIG. 14 is a flowchart of an embodiment of a process 400 suitable for manufacturing power production plants, and more specifically, power production plants that incorporate the techniques described herein. In the depicted embodiment, the process 400 may (block 402) manufacture or procure already manufactured systems, such as the gas turbine system 14, the gas turbine generator 42, the steam turbine 16, the steam turbine generator 52, the HRSG 18, and so on. Indeed, all of the systems depicted in the figures may be manufactured or procured. One example manufacturer of the gas turbine system 14, the gas turbine generator 42, the steam turbine 16, the steam turbine generator 52, and/or the HRSG 18 includes General Electric Co., of Schenectady, N.Y.

The process 400 may then install (block 404) the first GT/GTG/HRSG island 108. For example, the GT/GTG/HRSG island 108 or the GT/GTG/HRSG island 110 may be installed by disposing the gas turbine system 14, the gas turbine generator 42, and/or the HRSG 18 as shown in the figures. In certain embodiments, the GT/GTG/HRSG island 108, 110 may include a modular design and/or modular components that enable a faster and more efficient installation. The process 400 may then install the ST/STG island 106. The ST/STG island 106 may also include a modular design and/or modular components that enable a faster and more efficient installation. The ST/STG island 106 may be installed so that the/STG island 106 is disposed between the GT/GTG/HRSG island 108 or the GT/GTG/HRSG island 110, accordingly, the process 400 may then install (408) the second the GT/GTG/HRSG island 108 or 110 so that the ST/STG island 106 is between either the gas turbines 14 or the HRSGs 18, as described earlier.

The process 400 may then interconnect the various systems, such as the gas turbine system 14, the gas turbine generator 42, the steam turbine 16, the steam turbine generator 52, and/or the HRSG 18. For example, piping, electrical conduit, electrical distribution, mechanical coupling systems, and so on, may be used to interconnect the various systems. Accordingly, a power plant may be manufactured more efficiently, reducing material quantities and cost.

Technical effects of the invention include improved arrangements of certain systems in a 2×1 multi-shaft power island system that provide for a more efficient layout, such that the use of certain material for construction of the 2×1 multi-shaft power island system are minimized. Indeed, the arrangement of certain systems may result in less construction material quantities (e.g., piping material, electrical conduit material, and so on), lower cost of construction, and improved equipment access by construction, maintenance and/or operations personnel.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A 2×1 multi-shaft power island system, comprising:
a first gas turbine (GT)/gas turbine generator (GTG)/heat recovery steam generator (HRSG) island, the GT/GTG/HRSG island comprising:
a first gas turbine system configured to produce power by combusting a fuel;
a first turbine generator system mechanically coupled to the first gas turbine system and configured to produce electrical power;
a first HRSG system fluidly coupled to the first gas turbine system and configured to generate a first steam;
a second GT/GTG/HRSG island, comprising:
a second gas turbine system configured to produce power by combusting the fuel;
a second turbine generator system mechanically coupled to the second gas turbine system and configured to produce electrical power;
a second HRSG system fluidly coupled to the second gas turbine system and configured to generate a second steam;
a steam turbine system fluidly coupled to the first HRSG system and to the second HRSG system and configured to produce power via the first steam and the second steam; and
a steam turbine generator system mechanically coupled to the steam turbine system and configured to produce electrical power, wherein the steam turbine system is disposed in a location between the first GT/GTG/HRSG island and the second GT/GTG/HRSG island.

2. The system of claim 1, wherein the steam turbine system is disposed between the first HRSG system and the second HRSG system.

3. The system of claim 1, wherein the steam turbine system is disposed between the first gas turbine system and the second gas turbine system.

4. The system of claim 1, wherein the steam turbine system comprises a steam turbine centerline, and the first HRSG system comprises a first HRSG centerline, wherein and the steam turbine centerline is disposed perpendicular to the first HRSG centerline.

5. The system of claim 4, wherein the second HRSG system comprises a second HRSG centerline, wherein and the steam turbine centerline is disposed perpendicular to the second HRSG centerline.

6. The system of claim 5, wherein first HRSG centerline is disposed parallel to the second HRSG centerline.

7. The system of claim 1, comprising a first piping interconnecting the first HRSG system to the steam turbine system, wherein a longest first straight pipe run of the first piping is 150 ft. or less.

8. The system of claim 7, comprising a second piping interconnecting the second HRSG system to the steam turbine system, wherein a longest straight second pipe run of the second piping is 150 ft or less.

9. The system of claim 3, comprising a building, wherein the first gas turbine generator, the second gas turbine generator, and the steam turbine system, are disposed inside of the building.

10. A method of manufacturing, comprising:
manufacturing a first gas turbine (GT)/gas turbine generator (GTG)/heat recovery steam generator (HRSG) island on a site, the GT/GTG/HRSG island comprising:
a first gas turbine system configured to produce power by combusting a fuel;
a first turbine generator system mechanically coupled to the first gas turbine system and configured to produce electrical power;
a first HRSG system fluidly coupled to the first gas turbine system and configured to generate a first steam;
manufacturing a second GT/GTG/HRSG island on the site, comprising:
a second gas turbine system configured to produce power by combusting the fuel;
a second turbine generator system mechanically coupled to the second gas turbine system and configured to produce electrical power;
a second HRSG system fluidly coupled to the second gas turbine system and configured to generate a second steam;
disposing a steam turbine system on the site, the steam turbine system configured to fluidly couple to the first HRSG system and to the second HRSG system and to produce power via the first steam and the second steam; and
disposing a steam turbine generator system on the site, the steam turbine generator mechanically coupled to the steam turbine system and configured to produce electrical power, wherein the steam turbine system is disposed in a location on the site between the first GT/GTG/HRSG island and the second GT/GTG/HRSG island.

11. The method of claim 10, wherein the steam turbine system is disposed between the first HRSG system and the second HRSG system.

12. The method of claim 10, wherein the steam turbine system is disposed between the first gas turbine system and the second gas turbine system.

13. The method of claim 10, wherein the steam turbine system comprises a steam turbine centerline, and the first HRSG system comprises a first HRSG centerline, wherein and the steam turbine centerline is disposed perpendicular to the first HRSG centerline.

14. The method of claim 10, comprising interconnecting the first HRSG system to the steam turbine system via a piping, wherein a longest first straight pipe run of the piping is 150 ft. or less.

15. The method of claim 12, comprising constructing a building and disposing the first gas turbine generator, the second gas turbine generator, and the steam turbine system, inside of the building.

16. A combined cycle power plant system, comprising:
a first power production island configured to produce electrical power;
a second power production island configured to produce electrical power; and
a steam turbine island comprising a steam turbine system and a steam turbine generator system mechanically coupled to the steam turbine system and configured to produce electrical power, wherein the steam turbine island is disposed in a location between the first power production island and the second power production island.

17. The system of claim 16, wherein the first power production island comprises a gas turbine (GT)/gas turbine generator (GTG)/heat recovery steam generator (HRSG) island, the GT/GTG/HRSG island comprising:
a first gas turbine system configured to produce power by combusting a fuel;
a first turbine generator system mechanically coupled to the first gas turbine system and configured to produce electrical power;
a first HRSG system fluidly coupled to the first gas turbine system and configured to generate a first steam.

18. The system of claim 16, wherein the steam turbine system is disposed between the first HRSG system and the second power production island.

19. The system of claim 16, wherein the steam turbine system is disposed between the first gas turbine system and the second power production island.

20. The system of claim 16, wherein the steam turbine system comprises a steam turbine centerline, and the first HRSG system comprises a first HRSG centerline, wherein and the steam turbine centerline is disposed perpendicular to the first HRSG centerline.
